(19) United States
(12) Patent Application Publication
(10) Pub. No.: US 2026/0056411 A1
(43) Pub. Date: Feb. 26, 2026

(54) LARGER FIELD OF VIEW CURVED LIGHTGUIDE

(71) Applicant: GOOGLE LLC, Mountain View, CA (US)

(72) Inventor: Ozan Cakmakci, San Mateo, CA (US)

(21) Appl. No.: 19/105,867

(22) PCT Filed: Aug. 29, 2022
(86) PCT No.: PCT/US2022/041879

§ 371 Date: Feb. 24, 2025

(51) Int. Cl. G02B 27/01; G02B 1/04

(52) U.S. Cl. CPC G02B 27/0172; G02B 1/041; G02B 2027/0123; G02B 2027/013; G02B 2027/0178

(57) ABSTRACT

A curved lightguide that employs a freeform incoupler, a freeform world-facing surface, and a freeform outcoupler disposed between a spherical world-facing lens surface and a spherical eye-facing lens surface to achieve a relatively large FOV for display light and transmission of ambient light from the environment in a thin form factor.

### BACKGROUND

Wearable electronic eyewear devices include optical systems that magnify a display image and deliver a virtual image into the field of view (FOV) of a user. In some cases, wearable electronic eyewear devices also allow the user to see the outside world through a lens or see-through eyepiece. Some wearable electronic eyewear devices incorporate a near-to-eye optical system to display content to the user. These devices are sometimes referred to as head-mounted displays (HMDs). For example, conventional HMD designs include a microdisplay (“display”) positioned in a temple or rim region of a head wearable frame like a conventional pair of eyeglasses. The display generates images, such as computer-generated images (CGI), that are conveyed into the FOV of the user by optical elements such as curved lightguides deployed in the lens (or “optical combiner”) of the head wearable display frame. The wearable electronic eyewear device can therefore serve as a hardware platform for implementing augmented reality (AR) or mixed reality (MR). Different modes of augmented reality include optical see-through augmented reality, video see-through augmented reality, or opaque (VR) modes.

### BRIEF SUMMARY

In one example, a near-eye display may comprise a lens comprising a spherical world-facing surface and a spherical eye-facing surface and a lightguide disposed between the spherical world-facing surface and the spherical eye-facing surface. The lightguide includes a freeform incoupler, a freeform world-facing surface, and a freeform outcoupler. In an example, the freeform world-facing surface is coupled to the spherical world-facing surface with an optically clear adhesive.

In an example, the freeform world-facing surface and the optically clear adhesive are configured to totally internally reflect light having an angle of incidence of at least approximately 45 degrees.

In another example, the optically clear adhesive has a refractive index of approximately 1.2. In some examples, the optically clear adhesive comprises a porous material. In an example, the lens is plastic and less than approximately 5 mm thick. The near-eye display has a field of view of approximately 20×15 degrees without use of field elements in some examples.

The near-eye display further includes a microdisplay in some examples, wherein the freeform world-facing surface and the optically clear adhesive are configured to totally internally reflect light generated by the microdisplay coupled into the lightguide by the freeform incoupler. The freeform outcoupler is configured to outcouple the totally internally reflected light through the spherical eye-facing surface toward the eye of a user. The spherical world-facing surface and the spherical eye-facing surface are configured to transmit ambient light through the lightguide toward the eye of the user.

In another example, a near-eye display system includes a light engine, a lens comprising a spherical world-facing surface and a spherical eye-facing surface, and a lightguide disposed between the spherical world-facing surface and the spherical eye-facing surface. The lightguide includes a freeform incoupler, a freeform world-facing surface coupled to the spherical world-facing surface with an optically clear adhesive, wherein the freeform world-facing surface and the optically clear adhesive are configured to totally internally reflect light coupled into the lightguide by the freeform incoupler, and a freeform outcoupler configured to outcouple the totally internally reflected light through the spherical eye-facing surface toward the eye of a user. The lens and the lightguide are configured to transmit ambient light toward the eye of the user.

In one example, a method includes receiving ambient light at a spherical world-facing surface of a near-eye display system, coupling light generated at a light engine into a lightguide of the near-eye display system, the lightguide having a freeform incoupler and a freeform world-facing surface adhered to the spherical world-facing surface by an optically clear adhesive to direct the light generated at the light engine through the lightguide via total internal reflection and transmitting through a spherical eye-facing surface of the near-eye display system light outcoupled from the lightguide via a freeform outcoupler and ambient light received at the spherical world-facing surface.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example head-mounted display (HMD) employing a thin curved optical combiner through which images projected by the HMD are displayed with an enlarged field of view, in accordance with some embodiments.

FIG. 2 is a diagram illustrating a lightguide having a freeform incoupler, a freeform world-side surface adhered to a spherical world-side surface of a lens, a spherical eye-side surface, and a freeform outcoupler, in accordance with some embodiments.

FIG. 3 is a diagram illustrating the lightguide receiving display light from a microdisplay at the freeform incoupler and directing the light out of the lightguide through the spherical eye-side surface after interactions with the freeform world-side surface and the freeform outcoupler in accordance with some embodiments.

FIG. 4 is a flow diagram of a method of transmitting ambient light through a spherical world-facing surface and a spherical eye-facing surface of a lens while directing light received from a light engine through a lightguide having a freeform incoupler, a freeform world-facing surface, and a freeform outcoupler toward the eye of a user.

### DETAILED DESCRIPTION

Head-mounted displays (HMDs) potentially have multiple practical and leisure applications, but the development and adoption of wearable electronic display devices have been limited by constraints imposed by the optics, aesthetics, manufacturing process, thickness, field of view (FOV), and prescription lens limitations of the optical systems used to implement existing display devices. For example, the geometry and physical constraints of conventional designs result in displays having relatively small FOVs and relatively thick optical combiners.

The optical performance of an HMD is an important factor in its design; however, users also care significantly about aesthetics of wearable devices. Independent of their performance limitations, many of the conventional examples of wearable heads-up displays have struggled to find traction in consumer markets because, at least in part, they lack fashion appeal. Some wearable HMDs employ planar lightguides in planar transparent combiners and, as a result, appear very bulky and unnatural on a user's face compared to the sleeker and more streamlined look of typical curved eyeglass and sunglass lenses. Thus, it is desirable to integrate curved lenses with lightguides in wearable heads-up displays or eyewear in order to achieve the form factor and fashion appeal expected of the eyeglass and sunglass frame industry.

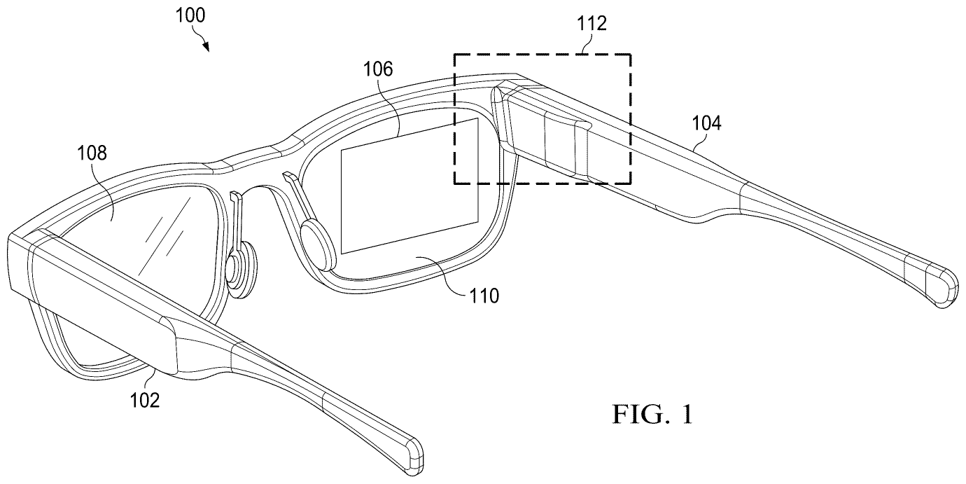

FIGS. 1-4 illustrate thin, curved lightguides (also referred to as waveguides) that employ a freeform incoupler, a freeform world-facing surface, and a freeform outcoupler disposed between a spherical world-facing lens surface and a spherical eye-facing lens surface to achieve a relatively large FOV for display light and transmission of ambient light from the environment in a thin form factor. The lightguides can be implemented in a variety of HMDs, including those with an eyeglass form factor. The term “freeform” refers to a surface that does not have symmetry around any axis.

The freeform world-facing surface of the lightguide is adhered to the spherical world-facing lens surface with an optically clear adhesive (OCA) having a low refractive index. Light impinging on the interface of the freeform world-facing surface of the lightguide and the OCA at a minimum angle of incidence of approximately 45 degrees experiences total internal reflection (TIR) within the lightguide. In some embodiments, the OCA has a refractive index of approximately 1.2 and is a porous material. The entire thickness of the optical combiner (i.e., the spherical world-facing surface and the spherical eye-facing surface, with the sandwiched between the two spherical surfaces) is approximately 4 mm in some embodiments while producing a FOV of approximately 20×15 degrees without the use of field elements. At the same time, the spherical world-facing surface and the spherical eye-facing surface transmit ambient light from the environment through the optical combiner without applying an optical power. Thus, both ambient light from the environment and display light directed through the lightguide and having an enlarged FOV are directed to an eye of a user via the thin, curved optical combiner.

FIG. 1 illustrates an example near-eye display system 100 (referred to as display system 100) employing a thin, curved lightguide providing an enlarged field of view in accordance with some embodiments. The display system 100 has a support structure 102 that includes an arm 104, which houses a projector (e.g., a laser projector, a micro-LED projector, a Liquid Crystal on Silicon (LCOS) projector, or the like). The projector is configured to project images toward the eye of a user via a lightguide, such that the user perceives the projected images as being displayed in a field of view (FOV) area 106 of a display at one or both of spherical lens elements 108, 110. In the depicted embodiment, the display system 100 is a near-eye display system in the form of a WHUD in which the support structure 102 is configured to be worn on the head of a user and has a general shape and appearance (that is, form factor) of an eyeglasses (e.g., sunglasses) frame.

The support structure 102 contains or otherwise includes various components to facilitate the projection of such images toward the eye of the user, such as a projector and a lightguide. In some embodiments, the support structure 102 further includes various sensors, such as one or more front-facing cameras, rear-facing cameras, other light sensors, motion sensors, accelerometers, and the like. In some embodiments, the support structure 102 includes one or more radio frequency (RF) interfaces or other wireless interfaces, such as a Bluetooth™ interface, a WiFi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1. It should be understood that instances of the term “or” herein refer to the non-exclusive definition of “or”, unless noted otherwise. For example, herein the phrase “X or Y” means “either X, or Y, or both”.

One or both of the spherical lens elements 108, 110 are used by the display system 100 to provide an augmented reality (AR) display in which rendered graphical content can be superimposed over or otherwise provided in conjunction with a real-world view as perceived by the user through the spherical lens elements 108, 110. For example, a projection system of the display system 100 uses light to form a perceptible image or series of images by projecting the light onto the eye of the user via a projector of the projection system, a lightguide formed at least partially in the corresponding spherical lens element 108 or 110, and one or more optical elements (e.g., one or more scan mirrors, one or more optical relays, or one or more collimation lenses that are disposed between the projector and the lightguide), according to various embodiments.

One or both of the spherical lens elements 108, 110 includes at least a portion of a curved lightguide that routes display light received by a freeform incoupler of the lightguide to a freeform outcoupler of the lightguide, which outputs the display light toward an eye of a user of the display system 100. The display light is magnified and collimated onto the eye of the user such that the user perceives the display light as an image. In addition, each of the spherical lens elements 108, 110 is sufficiently transparent to allow a user to see through the spherical lens elements to provide a field of view of the user's real-world environment such that the image appears superimposed over at least a portion of the real-world environment.

In some embodiments, the projector of the projection system of the display 100 is a digital light processing-based projector, a scanning laser projector, or any combination of a modulative light source, such as a laser or one or more light-emitting diodes (LEDs), and a dynamic reflector mechanism such as one or more dynamic scanners, reflective panels, or digital light processors (DLPs). In some embodiments, the projector includes a micro-display panel, such as a micro-LED display panel (e.g., a micro-AMOLED display panel, or a micro inorganic LED (i-LED) display panel) or a micro-Liquid Crystal Display (LCD) display panel (e.g., a Low Temperature PolySilicon (LTPS) LCD display panel, a High Temperature PolySilicon (HTPS) LCD display panel, or an In-Plane Switching (IPS) LCD display panel). In some embodiments, the projector includes a Liquid Crystal on Silicon (LCOS) display panel. In some embodiments, a display panel of the projector is configured to output light (representing an image or portion of an image for display) into the lightguide of the display system. The lightguide expands the light and outputs the light toward the eye of the user via an outcoupler.

The projector is communicatively coupled to the controller and a non-transitory processor-readable storage medium or memory storing processor-executable instructions and other data that, when executed by the controller, cause the controller to control the operation of the projector. In some embodiments, the controller controls the projector to selectively set the location and size of the FOV area 106. In some embodiments, the controller is communicatively coupled to one or more processors (not shown) that generate content to be displayed at the display system 100. The projector outputs light toward the FOV area 106 of the display system 100 via the lightguide. In some embodiments, at least a portion of an outcoupler of the lightguide overlaps the FOV area 106.

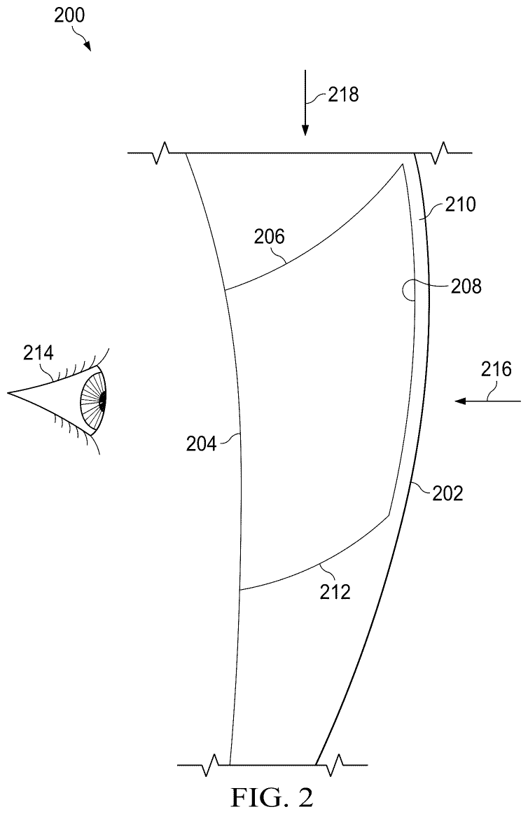

FIG. 2 illustrates a lightguide 200 having a freeform incoupler 206, a freeform world-side surface 208 adhered to a spherical world-side surface 202 of a lens with an optically clear adhesive 210, a spherical eye-side surface 204, and a freeform outcoupler 212, in accordance with some embodiments. The freeform outcoupler 212 is optically aligned with an eye 214 of a user in the present example. In some embodiments, the lightguide 200 is implemented in a wearable heads-up display or other display system, such as the HMD system 100 of FIG. 1.

The term “lightguide,” as used herein, refers to a combiner using one or more of total internal reflection (TIR), specialized filters, or reflective surfaces, to transfer light 218 generated by a microdisplay (not shown) from an incoupler (such as the freeform incoupler 206) to an outcoupler (such as the freeform outcoupler 212). In some display applications, light 218 entering the freeform incoupler 206 is a cone, and interactions with the optical surfaces of the lightguide 200 convert the cone into collimated light (i.e., parallel rays) so that it appears to a user as if the light originated at a distance in front of the user. In the present example, the light 218 received at the freeform incouple 206 is relayed to the freeform outcoupler 212 via the lightguide 200 using TIR. In general, the terms “incoupler” and “outcoupler” will be understood to refer to any type of optical grating structure, including, but not limited to, refractive or reflective freeform surfaces, diffraction gratings, holograms, holographic optical elements (e.g., optical elements using one or more holograms), volume diffraction gratings, volume holograms, surface relief diffraction gratings, or surface relief holograms. The laser light 218 is then output to the eye 216 of a user via the outcoupler 214. As described above, in some embodiments the lightguide 200 is implemented as part of an eyeglass lens, such as the lens 108 or lens 110 (FIG. 1) of the display system having an eyeglass form factor.

The interface of the freeform world-facing surface 208 and the optically clear adhesive 210 that bonds the freeform world-facing surface 208 to the spherical world-facing surface 210 causes light 218 to experience TIR between the freeform world-facing surface 208 and the spherical eye-facing surface 204 when the light 218 impinges on the freeform world-facing surface at an angle of approximately 45 degrees. In some embodiments, the optically clear adhesive 210 has a refractive index of n=1.2. In some embodiments, the optically clear adhesive 210 is a porous material. Following TIR within the lightguide 200, the light 218 is then output to the eye 214 of a user via the outcoupler 212. In some embodiments, the FOV of the lightguide 200 is 20×15 degrees without the use of any field elements.

In some embodiments, the shapes of each of the freeform incoupler 206, the freeform world-facing surface 208, and the freeform outcoupler 212 are described by a height (also referred to as a sag) z from each point (x,y) along a plane, wherein r is a base sphere term and j is an index:

$$z = \frac{c {r}^{2}}{1 + \sqrt{1 - ( 1 + k ) {c}^{2} {r}^{2}}} + {\sum }_{j = 2}^{66} {C}_{j} {x}^{m} {y}^{n} \qquad ( 1 )$$

$$where j = \frac{{( m + n )}^{2} + m + 3 n}{2} + 1 \qquad ( 2 )$$

Thus, for example, if m=1 and n=0, j=2. In some embodiments, the coefficients used in equations (1) and (2) differ for each of the freeform incoupler 206, the freeform world-facing surface 208, and the freeform outcoupler 212. The coefficients are selected based on the performance goals for the design.

Although not shown in the example of FIG. 2, in some embodiments additional optical components are included in any of the optical paths between the microdisplay and the incoupler 206, or between the outcoupler 212 and the eye 214 (e.g., in order to shape the light for viewing by the eye 214 of the user). For example, in some embodiments, a prism (not shown) is used to steer light from the microdisplay into the incoupler 206 so that light is coupled into incoupler 206 at the appropriate angle to encourage propagation of the light in lightguide 200 by TIR. Also, in some embodiments, an exit pupil expander is arranged in an intermediate stage between incoupler 206 and outcoupler 212 to receive light that is coupled into lightguide 200 by the incoupler 206, expand the light, and redirect the light towards the outcoupler 212, where the outcoupler 212 then couples the light out of lightguide 200.

Ambient light 216 from the environment impinging on the spherical world-side surface 202 is transmitted through the lightguide 200 and the spherical eye-side surface 204 such that a user can see the real-world environment. In some embodiments, the combination of the spherical world-side surface 202 and the spherical eye-side surface 204 impart no optical power to the ambient light 216. In some embodiments, the distance between the spherical world-facing surface 202 and the spherical eye-facing surface 204 is approximately 4 millimeters.

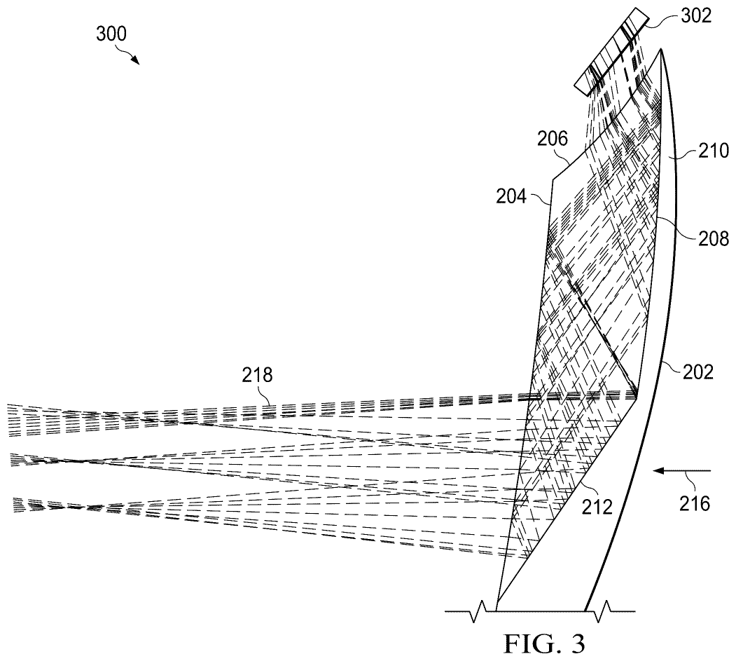

FIG. 3 is a diagram illustrating the lightguide 200 receiving light 218 from a microdisplay 302 at the freeform incoupler 206 and directing the light 218 through the spherical eye-side surface 204 in accordance with some embodiments. The microdisplay 302 includes one or more light sources configured to generate and output light 218 (e.g., visible light such as red, blue, and green light and, in some embodiments, non-visible light such as infrared light). In some embodiments, the microdisplay 302 is coupled to a driver or other controller (not shown), which controls the timing of emission of light from the light sources of the microdisplay 302 in accordance with instructions received by the controller or driver from a computer processor coupled thereto to modulate the light 218 to be perceived as images when output to the retina of an eye 214 of the user.

The light 218 is coupled into the lightguide 200 by the incoupler 206 and impinges on the freeform world-facing surface 208 at an approximately 45 degree angle. For example, if the freeform world-facing surface is made of plastic having a refractive index n=1.67 and the optically clear adhesive has a refractive index n=1.2, light having an angle of incidence a sin(1.2/1.67)=45.9 degrees will experience TIR.

When the light 218 encounters the interface of the freeform world-facing surface and the optically clear coating 210, the light experiences a total internal reflection and is reflected toward the spherical eye-facing surface 204, where the light 218 experiences another TIR until the light 218 impinges on the freeform outcoupler 212, which directs the light 218 out of the lightguide 200 toward the eye 214 of the user. In some embodiments, the lightguide 200 provides a 20-degree FOV.

At the same time, ambient light 216 impinging on the spherical world-facing surface 202 is transmitted directly through the lightguide 200 and out of the spherical eye-facing surface 204 without being affected by any optical power. Thus, the user is able to view both the environment and light 218 emitted by the microdisplay 302.

The porous material 210 between the freeform world-facing surface 208 and the spherical surface 202 enables a greater field of view by allowing the freeform world-facing surface 208 to tilt less, even with a distance between the spherical world-facing surface 202 and the spherical eye-facing surface 204 of approximately 4 millimeters.

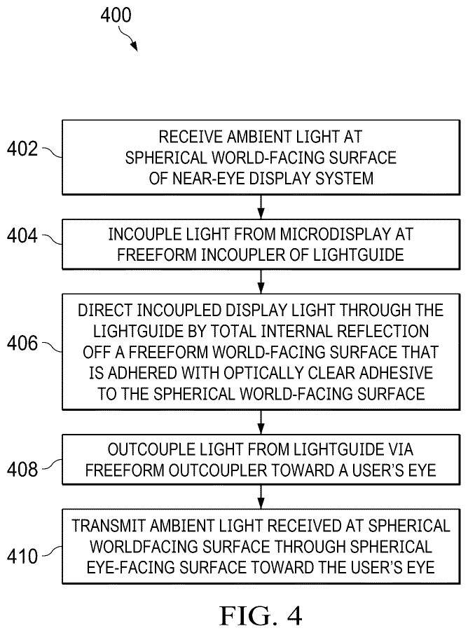

FIG. 4 is a flow diagram of a method 400 of transmitting ambient light through a spherical world-facing surface and a spherical eye-facing surface of a lens while directing light received from a light engine through a lightguide having a freeform incoupler, a freeform world-facing surface, and a freeform outcoupler toward the eye of a user. In some embodiments, the method 400 is performed, at least in part, by an embodiment of the lightguides 200 and 300 of FIGS. 2 and 3 and the near-eye display system 100 of FIG. 1.

At block 402, a near-eye display system employing a lightguide 200 receives ambient light 216 at a spherical world-facing surface 202. At block 404, light from a microdisplay 302 is incoupled to the lightguide 200 by the freeform incoupler 206. At block 406, light 218 that is incoupled from the microdisplay 302 is directed through the lightguide 200 by total internal reflection off the freeform world-facing surface 208 that is adhered to the spherical world-side surface 202 with the optically clear adhesive 210.

At block 408, light 218 that was incoupled from the microdisplay 302 and directed through the lightguide 200 by TIR is outcoupled from the lightguide 200 by the freeform outcoupler 212 toward the user's eye 214. At block 410, the ambient light 216 that was received at the spherical world-facing surface 202 is transmitted through the spherical eye-facing surface 204 toward the user's eye 214. It should be noted that blocks 402 and 410 occur substantially simultaneously with blocks 404, 406, and 408.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A near-eye display comprising:
a lens comprising a spherical world-facing surface and a spherical eye-facing surface; and
a lightguide disposed between the spherical world-facing surface and the spherical eye-facing surface, the lightguide comprising:
a freeform incoupler;
a freeform world-facing surface; and
a freeform outcoupler,
wherein the freeform world-facing surface is coupled to the spherical world-facing surface with an optically clear adhesive.

2. The near-eye display of claim 1, wherein the freeform world-facing surface and the optically clear adhesive are configured to totally internally reflect light having an angle of incidence of at least approximately 45 degrees.

3. The near-eye display of claim 1, wherein the optically clear adhesive has a refractive index of approximately 1.2.

4. The near-eye display of claim 1, wherein the optically clear adhesive comprises a porous material.

5. The near-eye display of claim 1, wherein the lens is plastic and less than approximately 5 mm thick.

6. The near-eye display of claim 1, wherein the near-eye display has a field of view of approximately 20×15 degrees without use of field elements.

7. The near-eye display of claim 1, further comprising a microdisplay, wherein
the freeform world-facing surface and the optically clear adhesive are configured to totally internally reflect light generated by the microdisplay coupled into the lightguide by the freeform incoupler;
the freeform outcoupler is configured to outcouple the totally internally reflected light through the spherical eye-facing surface toward the eye of a user; and
the spherical world-facing surface and the spherical eye-facing surface are configured to transmit ambient light through the lightguide toward the eye of the user.

8. A near-eye display system, comprising:
a light engine;
a lens comprising a spherical world-facing surface and a spherical eye-facing surface; and
a lightguide disposed between the spherical world-facing surface and the spherical eye-facing surface, the lightguide comprising:
a freeform incoupler;
a freeform world-facing surface coupled to the spherical world-facing surface with an optically clear adhesive, wherein the freeform world-facing surface and the optically clear adhesive are configured to totally internally reflect light coupled into the lightguide by the freeform incoupler; and
a freeform outcoupler configured to outcouple the totally internally reflected light through the spherical eye-facing surface toward the eye of a user,
wherein the lens and the lightguide are configured to transmit ambient light toward the eye of the user.

9. The near-eye display system of claim 8, wherein the freeform world-facing surface and the optically clear adhesive are configured to totally internally reflect light having an angle of incidence of at least approximately 45 degrees.

10. The near-eye display system of claim 8, wherein the optically clear adhesive has a refractive index of approximately 1.2.

11. The near-eye display system of claim 8, wherein the optically clear adhesive comprises a porous material.

12. The near-eye display system of claim 8, wherein the lens is plastic and less than approximately 5 mm thick.

13. The near-eye display system of claim 8, wherein the near-eye display system has a field of view of approximately 20×15 degrees without use of field elements.

14. A method, comprising:
receiving ambient light at a spherical world-facing surface of a near-eye display system;
coupling light generated at a light engine into a lightguide of the near-eye display system, the lightguide having a freeform incoupler and a freeform world-facing surface adhered to the spherical world-facing surface by an optically clear adhesive to direct the light generated at the light engine through the lightguide via total internal reflection; and
transmitting through a spherical eye-facing surface of the near-eye display system light outcoupled from the lightguide via a freeform outcoupler and ambient light received at the spherical world-facing surface.

15. The method of claim 14, further comprising:
totally internally reflecting, by the freeform world-facing surface and the optically clear adhesive, light having an angle of incidence of at least approximately 45 degrees.

16. The method of claim 14, wherein the optically clear adhesive has a refractive index of approximately 1.2.

17. The method of claim 14, wherein the optically clear adhesive comprises a porous material.

18. The method of claim 14, wherein a stack comprising the spherical world-facing surface, the lightguide, and the spherical eye-facing surface is less than approximately 5 mm thick.

19. The method of claim 14, wherein the near-eye display system has a field of view of approximately 20×15 degrees without use of field elements.

20. The method of claim 14, further comprising:
applying no optical power to the ambient light received at the spherical world-facing surface and transmitted through the spherical eye-facing surface.
